(19) United States
(12) Patent Application Publication
(10) Pub. No.: US 2020/0096311 A1
(43) Pub. Date: Mar. 26, 2020

(54) OCT system calibration method for improved image resolution and reduced image artifacts

(71) Applicant: Axsun Technologies, Inc., Billerica, MA (US)

(72) Inventors: Bartley C. Johnson, North Andover, MA (US); Timothy N. Ford, Acton, MA (US); Seungbum Woo, Bedford, MA (US); Walid A. Atia, Jamaica Plain, MA (US)

(21) Appl. No.: 16/580,847

(22) Filed: Sep. 24, 2019

Related U.S. Application Data
(60) Provisional application No. 62/735,527, filed on Sep. 24, 2018.

(51) Int. Cl. G01B 9/02

(52) U.S. Cl. CPC G01B 9/02072; G01B 9/02091

(57) ABSTRACT

Methods and systems for increasing resolution and mitigating sidelobe artifacts on point spread functions in optical coherence tomography systems by addressing (1) the swept source's power variation across the scan band, (2) errors in sampling instances, and (3) window function selection.

### RELATED APPLICATIONS

This application claims the benefit under 35 USC 119(e) of U.S. Provisional Application No. 62/735,527, filed on Sep. 24, 2018, which is incorporated herein by reference in its entirety.

### BACKGROUND OF THE INVENTION

Optical coherence analysis and specifically optical coherence tomography (“OCT”) are important medical imaging tools that use light to capture three-dimensional images in micrometer-resolution non-invasively from the sub-surface of a sample, such as a biological tissue. Nevertheless, OCT is also useful for such applications as industrial inspection, among others.

A common OCT technique is Fourier domain OCT (“FD-OCT”), of which there are generally two types: Spectral Domain OCT and Swept Source OCT. In both systems, optical waves are reflected from an object or sample and interfered with reference waves. These waves are referred to as OCT interference signals, or simply as interference signals. A computer produces images of two-dimensional cross sections or three-dimensional volume renderings of the sample. Spectral Domain OCT and Swept Source OCT systems differ, however, in the type of optical source that they each utilize and how the interference signals are detected.

Spectral Domain OCT systems use a broadband optical source and a spectrally resolving detector system to determine the different spectral components in a single axial scan (“A-scan”) of the sample. Thus, spectral Domain OCT systems usually decode the spectral components of an interference signal by spatial separation. As a result, the detector system is typically complex, as it must detect the wavelengths of all optical signals in the scan range simultaneously, and then convert them to a corresponding interference dataset.

In contrast, Swept Source OCT systems encode spectral components in time, not by spatial separation. Swept Source OCT systems typically utilize wavelength (frequency) swept sources that “sweep” in the scan range or scan band. The interference signals are then typically detected by a non-spectrally resolving detector or specifically a balanced detector system.

Compared to Spectral Domain OCT technology, Swept Source OCT often does not suffer from inherent sensitivity degradation at longer imaging depths, and reduces the complexity of the detector system.

### SUMMARY OF THE INVENTION

A point spread function (PSF) is a way of characterizing the performance of an imaging system. It refers to the system's response to a point source or point object. In functional terms it is the spatial domain version of the optical transfer function of the imaging system. The degree of spreading (blurring) of the point object is a measure for the quality of an imaging system.

Fourier domain OCT systems encode the depth difference between the sample, and structures of and within the sample, and reference arms in the interference fringes in the spectral domain. The axial resolving power is determined by the spectral bandwidth, i.e., the swept source's scan band or the broadband source's spectral width. The PSF is the Fourier transform of the temporal or spatial distributed interference fringes for a point source reflection, such as a mirror.

While sidelobe artifacts on PSFs can have many causes, a few are: (1) the swept source's power variation across the scan band, (2) errors in sampling instances, and (3) window functions.

The invention relates to methods and systems for correcting for one or more of these issues. In general, the approaches can leverage a system calibration step and involve added signal processing. Although, for systems that slowly age, the recalibration step could be performed in the field with a fixtured target.

In general, according to one aspect, the invention features a method for calibrating and processing A-lines in an optical coherence tomography system. The method comprises measuring a response of the system of a calibration fixture and performing spectral flattening of subsequent A-lines taken from a sample in response to the measured response of the calibration fixture.

In embodiments, the calibration fixture includes a mirror.

In a preferred embodiment, the method also comprises resampling the A-lines. This dramatically improve performance. This can include performing fractional sample correction of A-lines and/or band-limited interpolation prior to resampling. The resampling can be based on measuring the response of the system to the calibration fixture.

In another innovation, multi window processing of the A-lines is performed. This can include employing parameterized windows such as Kaiser-Bessel, Dolph-Chebyshev, or other adjustable windows.

In general, according to another aspect, the invention features a method for processing A-lines in an optical coherence tomography system, comprising obtaining A-lines from a sample and performing multi window processing of the A-lines.

In general, according to another aspect, the invention features an optical coherence tomography system. The system comprises a sample interferometer, a digital acquisition system for digitizing A-lines from the sample interferometer, a calibration fixture for the sample interferometer, and an image processing computer for performing spectral flattening of A-lines taken from a sample in response to a measured response to the calibration fixture.

In general, according to another aspect, the invention features an optical coherence tomography system, comprising a sample interferometer, a digital acquisition system for digitizing A-lines from the sample interferometer, and an image processing computer for performing multi window processing of the A-lines.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 shows a schematic diagram of a swept source optical coherence analysis system;

FIG. 2A is a plot of OCT point-spread functions as a function of depth in millimeters (mm) as sampled, processed with dispersion correction and a Hann window;

FIG. 2B shows spectrally-flattened point-spread functions, dispersion compensation and a Hann window;

FIG. 2C is a plot of spectrally-flattened and resampled point-spread functions, dispersion compensation and a Hann window;

FIG. 2D is a plot of point-spread functions created using multiwindow processing applied after spectral-flattening, resampling, and dispersion compensation;

FIG. 3 is a flow diagram showing the process for extracting the inverse window;

FIG. 4 contains a series plots showing the processing of a calibration scan to obtain the inverse window;

FIG. 5 is a flow diagram showing the steps for computing the clocking errors during calibration;

FIG. 6 contains a series of plots showing the processing to obtain the clock error correction;

FIG. 7 is a plot as a function of depth in millimeters comparing several Kaiser-Bessel windows with the multiwindow calculation for 3 values of 1 to 10 in steps of 0.1;

FIG. 8 compares point-spread width as a function of sidelobe levels showing the tradeoffs between spatial resolution and sidelobe level for various window types (“KB” is used to indicate the Kaiser-Bessel family of windows);

FIG. 9A is a flow diagram showing the processing of A-line scans into image space using conventional windowing along with spectral flattening and resampling;

FIG. 9B is a flow diagram showing the processing of A-line scans into image space using multiple window processing along with spectral flattening and resampling;

FIG. 10 is a flow diagram showing the steps for resampling based on the computed clocking errors:

FIG. 11 is a plot of laser amplitude data that is inverted to become an inverse flattening window obtained from image data, rather than a test mirror fixture; and

FIG. 12A is a raw image of a fingertip, FIG. 12B shows a spectrally-flattened image, and FIG. 12C shows a spectrally-flattened with multiwindow processing to improve resolution and reduce sidelobes.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

It will be understood that although terms such as “first” and “second” are used herein to describe various elements, these elements should not be limited by these terms. These terms are only used to distinguish one element from another element. Thus, an element discussed below could be termed a second element, and similarly, a second element may be termed a first element without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

There are many configurations of Fourier Domain optical coherence tomography (OCT) systems. Examples include spectral domain systems and swept source systems.

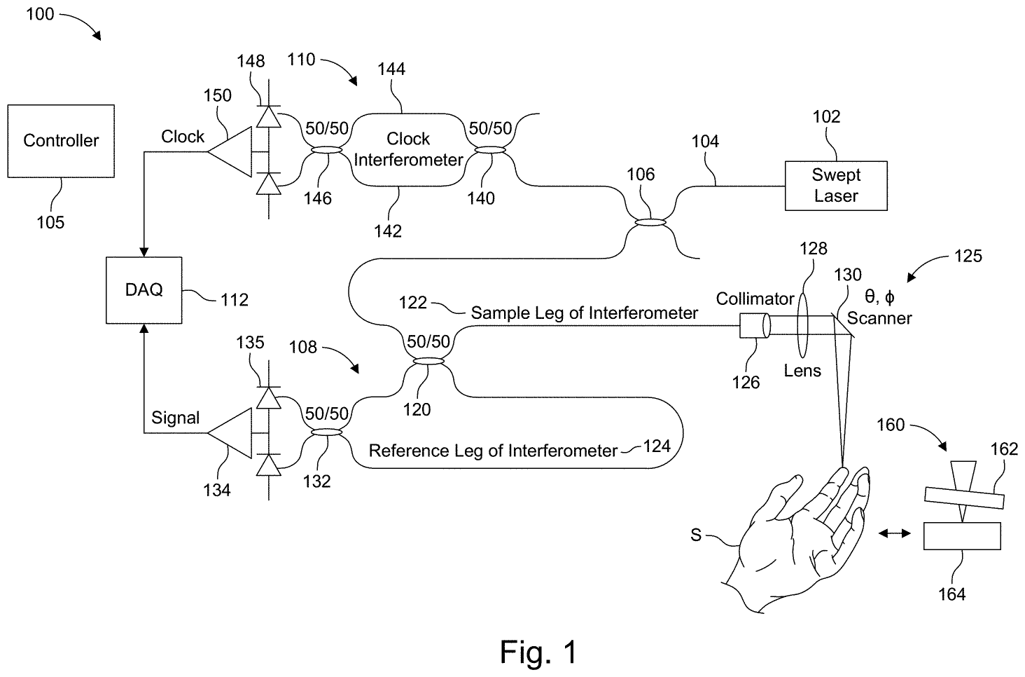

FIG. 1 shows an example of a swept source optical coherence tomography imaging system 100.

That said, many other system configurations are possible, and everything discussed here also applies to spectral domain systems as well as the exemplary swept source system illustrated here.

In general, these systems incorporate an optical probe 125, an interferometer 108 and clocking system 110, and data acquisition 112 and imaging processing computer such as a controller 105 or other computer.

Two types of signal acquisition are envisioned by the methods in this invention. In the first case, clock transitions trigger the sampling of the signal by the data acquisition board (DAQ) 112. This is called direct clocking. In a second scheme, a data acquisition board (DAQ) 112 samples the signal and reference interferometer (i.e. the clock) data at a constant 100 MS/s rate or faster and a computer resamples the signal at uniform optical frequency intervals.

In the illustrated example, the OCT system 100 uses a swept source 102 to generate wavelength swept optical signals on optical fiber 104. The swept source 102 is typically a tunable laser designed for high speed spectral sweeping. The swept optical signals are narrowband emissions that are scanned, or “swept,” over the spectral scan band. Tunable lasers are constructed from a gain element such as a semiconductor optical amplifier (“SOA”) that is located within a resonant laser cavity, and a tuning element such as a rotating grating, a grating with a rotating mirror, or a Fabry-Perot tunable filter. Another common laser is the vertical surface emitting laser (VCSEL). Especially, VCSELs with microelectromechanical system (MEMS) tunable mirrors are especially fast. Tunable lasers are known in the art, such as those described in U.S. Pat. Nos. 7,415,049, 8,526,472, and 10,109,979, which are incorporated herein by reference in their entirety.

A source fiber coupler 106 or other optical splitter divides the swept optical signal from the swept source 102 into a portion that is provided to an OCT interferometer 108 and a portion that is provided to a k-clock module 110. The controller 105 such as a host computer controls the swept source 102 and a data acquisition system (DAQ) 112. The DAQ samples the interference signal and receives the clock signal from the k-clock module 110, either as another analog signal to be sampled at a constant rate, or as a digital clock to trigger sampling of the analog signal at the output of the balanced receiver 134/135.

The interferometer 108 sends optical signals to a sample S, analyzes the optical signals reflected from the sample, and generates an optical interference signal in response.

In the illustrated example, a first interferometer fiber coupler 120 divides the light from the source 102 between a sample leg 122 of the interferometer 108 and a reference leg 124 of the interferometer.

The fiber of sample leg 122 couples to an optical probe 125. The illustrated probe includes collimator 126. A lens 128 focuses the light emitted from the collimator 126 and couples return light back into the sample leg 122 via the collimator 126. Typically, a scanner 130, such as a tip/tilt mirror scanner, controlled by the controller 105 scans the light emitted from the sample leg over the sample to build up a three dimensional volumetric image of the sample S.

The system also includes a calibration fixture 160 that is placed under the optical probe 125 instead of a sample S. The present calibration fixture 160 includes an optical attenuator 162 for absorbing some of the light from the probe 125. A mirror 164 reflects the light back into the probe 125.

Light returning from the sample S or fixture 160 on the sample leg 122 is coupled through the first interferometer fiber coupler 120 to a second interferometer fiber coupler 132, which mixes the light from the sample with the light from the reference leg 124.

An interferometer balanced detector system 135 detects the light from the second interferometer fiber coupler 132. This interference signal is amplified by an interferometer amplifier 134 and then sampled by the DAQ 112.

On the other hand, the light from the other leg of the source fiber coupler 106 is provided to the k-clock module 110. The k-clock module 110 generates optical k-clock signals at equally spaced optical frequency sampling intervals as the swept optical signal is tuned or swept over the scan band. The optical k-clock signals are converted into electronic k-clock signals, which are used by the data acquisition system 112 to track the frequency tuning of the optical swept source 102.

The particular illustrated example uses a fiber interferometer that comprises a first clock fiber coupler 140, two fiber legs 142, 144 and a second clock fiber coupler 146. The k-clock light is then detected by clock balanced detector system 148. Its signal is amplified by a clock amplifier 150.

Some Swept Source OCT systems use a hardware-based k-clocking. The k-clock signal is used to directly clock the Analog-to-Digital (“A/D”) converter of the DAQ 112 for sampling the electronic interference signals from the balanced detector 135. An alternative is a software-based k-clocking, wherein the k-clock signals are sampled at a fixed rate in time from the k-clock module 110 in the same manner as the interference signal from the main interferometer 108, creating a k-clock dataset of all sampled k-clock signals and an interference dataset of all sampled interference signals. Then, the k-clock dataset is used to resample the interference dataset. The resampling provides data that are evenly spaced in the optical frequency domain, or k-space.

The data processed here was taken using a tunable vertical cavity surface emitting laser (VCSEL) module as a swept source. The configuration is illustrated in U.S. Pat. No. 10,109,979. The specific device used had an 825 nanometer (nm) pump laser, 825 nm/1060 nm dichroic filter, optically pumped MEMS tunable VCSEL, 1060 nm isolator, and 1060 nm semiconductor optical amplifier (SOA) all co-packaged in a 14-pin butterfly module. The point-spreads were taken with a variable path-length sample interferometer. The fiber Mach-Zehnder clock interferometer 110 was cut to provide an 8 mm Nyquist depth when direct sampling. The clock interferometer directly triggered sampling in the DAQ. Each point spread curve is the average of 100 separate A-lines at one mirror position.

Although these example data were taken with a VCSEL, the methods apply to any type of swept source. In addition, these methods can be applied to spectral domain OCT systems.

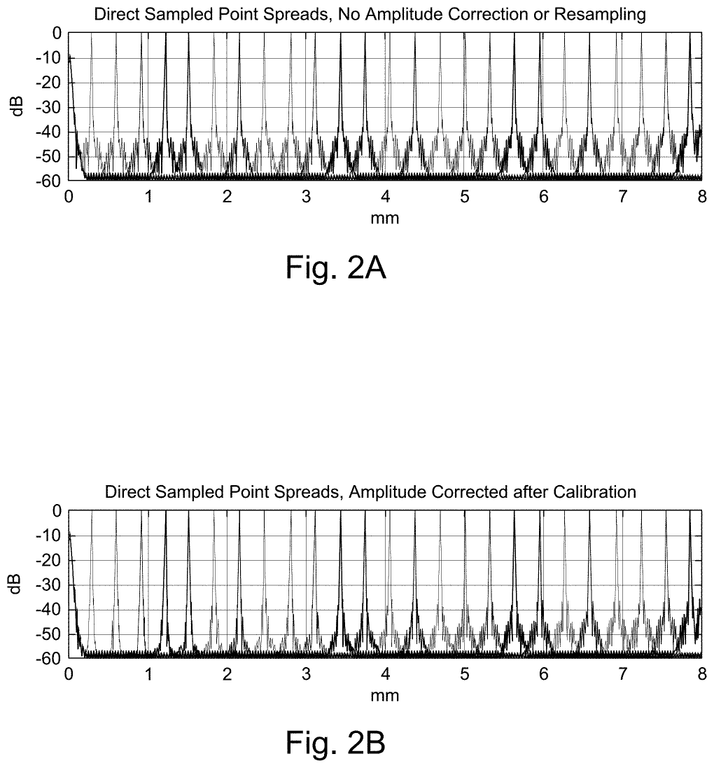

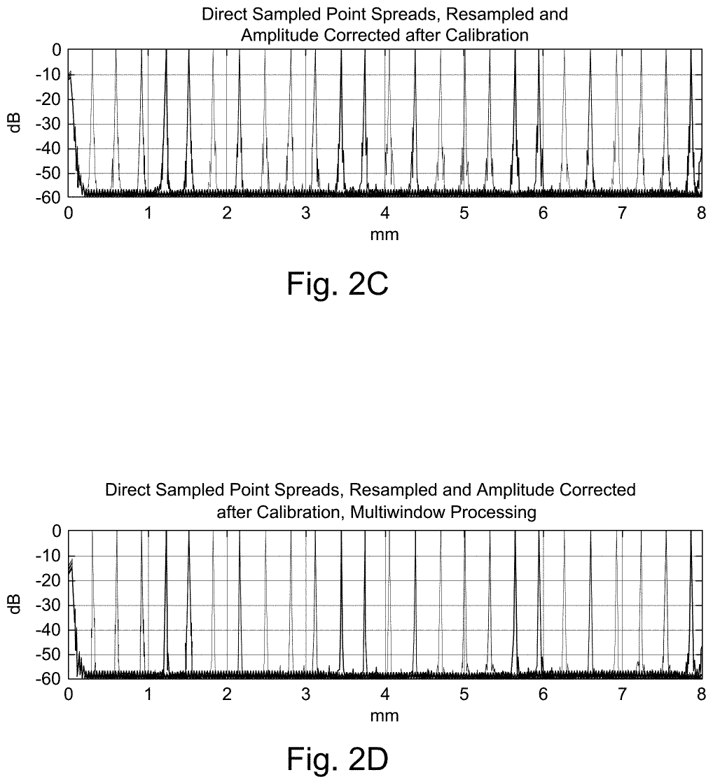

FIG. 2A-2D show successive levels of data compensation and correction that are performed by an image processing computer such as controller 105 in order to process the data including A-lines from the DAQ 112 into images such as three dimensional volumetric images of the sample, for example.

Specifically, the uncompensated, but dispersion corrected, point spreads are plotted in FIG. 2A. The first level of compensation, FIG. 2B, allows the image processing computer to correct for the laser power variation over the wavelength sweep range. An inverse window is measured and used to effectively make the laser power flat over the wavelength range. The term “spectral flattening” is used to describe the process. This compensates both for fine variations that lead to side lobes, and the overall broad power variation that decreases resolution.

Correction for systematic clocking errors by the image processing computer eliminates the pedestals that rise with depth seen in FIG. 2B, but are eliminated in FIG. 2C.

FIG. 2C shows point spreads obtained using a Hann window in the Fourier transform process to obtain an image. FIG. 2D shows the effect of the image processing computer employing a multiwindow signal processing method that can increase resolution to the level obtained with a rectangular window, but without the deleterious sidelobes associated with a rectangular window. This method allows higher resolution to be achieved without having to increase the tuning range of the swept source.

Amplitude Correction (Spectral Flattening)

Software (see S. Kim. P. Raphael, J. Oghalai, and B. Applegate, “High-speed spectral calibration by complex FIR filter in phase-sensitive optical coherence tomography,” Biomed. Opt. Express 7, 1430-1444 (2016); and R. Tripathi, N. Nassif, J. Nelson, B. Park, and J. de Boer, “Spectral shaping for non-Gaussian source spectra in optical coherence tomography,” Opt. Lett. 27, 406-408 (2002), and hardware, see A. Akcay, J. Rolland, and J. Eichenholz, “Spectral shaping to improve the point spread function in optical coherence tomography,” Opt. Lett. 28, 1921-1923 (2003)) spectral flattening has been demonstrated for time-domain OCT systems. Hardware spectral shaping by varying laser SOA currents for increasing resolution, but not for eliminating side-lobes, has also been proposed by J. Kolb, T. Pfeiffer, M. Eibl, H. Hakert, and R. Huber, “High-resolution retinal swept source optical coherence tomography with an ultra-wideband Fourier-domain mode-locked laser at MHz A-scan rates,” Biomed. Opt. Express 9, 120-130 (2018) for swept sources.

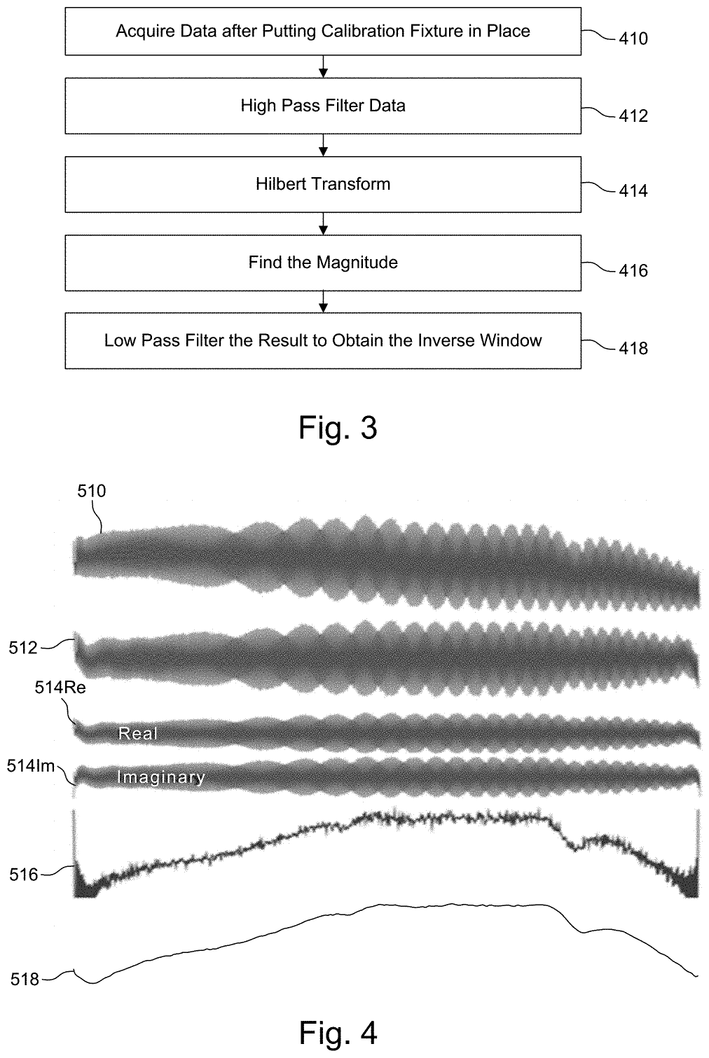

FIG. 3 shows a data processing method employed by the image processing computer such as the controller 105, for example, for determining an inverse window for spectral flattening during an initial calibration, according to the present approach.

In step 410, an A-line, with the calibration fixture 160 in place, is captured. This data is plot 510 of FIG. 4. This plots the interference signal as a function of frequency as the swept source is swept through the scan band. The raw A-line also contains artifacts. One is that that power from the swept source 102 varies over the scan band.

The A-line data is then high pass filtered in step 412. This data is plot 512 of FIG. 4. The slowly varying average across the scan is thus removed.

A Hilbert transform is then performed on the high pass filtered data in step 414. This yields an imaginary component, see plot 514Re of FIG. 4, and an imaginary component, see plot 514Im in FIG. 4.

In step 416, the magnitude of the Hilbert transformed data is calculated. This data is plot 516 in FIG. 4.

In step 416, the amplitude information is extracted from the nearly sinusoidal wave by taking the absolute value after Hilbert transforming the data. This data is plot 516 of FIG. 4. The data is then low pass filtered. This yields an “inverse window” as shown in plot 518 of FIG. 4.

This process for finding the “inverse window” is used by the image processing computer for spectral flattening the OCT data and specifically the raw A-lines taken of any sample S. The inverse amplitude window is proportional to the laser power across the wavelength sweep. The VCSEL power has both broad features that reduce resolution and fine features that result in sidelobes.

Clock Correction

Comparing FIG. 2A to FIG. 2B shows the result of the amplitude correction. The sidelobes of FIG. 2A are much reduced in FIG. 2B as a result of the spectral flattening. Nevertheless, the remaining sidelobes show a trend, increasing with depth. This is suggestive of clocking error. See B. Johnson, W. Atia, D. Flanders, M. Kuznetsov, B. Goldberg, N. Kemp, and P. Whitney, “SNR of swept SLEDs and swept lasers for OCT,” Opt. Express 24, 11174-11186 (2016).

This clocking error cannot be fixed by a simple complex phase window correction. The problem is that the clock transition times are slightly wrong. As a result, the data must be resampled. The errors in clocking transitions can be measured using a calibration step, again using the calibration fixture 160.

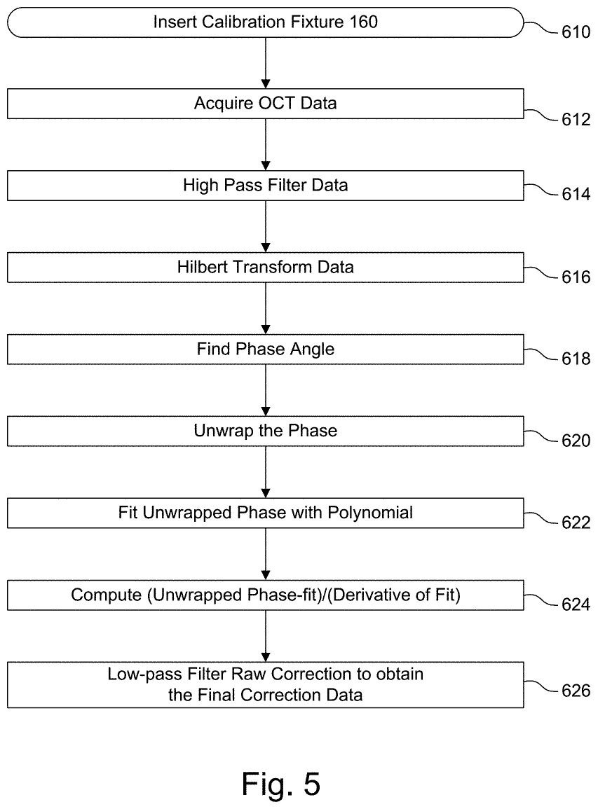

FIG. 5 shows the steps for the image processing computer to compute the clocking errors by calibrating using the calibration fixture 160. The phase of the roughly sinusoidal calibration signal is fit to a polynomial of 2nd or possibly higher-order polynomial to screen out the dispersion in the sample interferometer. Dispersion is not a clocking error.

In more detail, in step 610, the calibration fixture 160 is inserted into the OCT system 100.

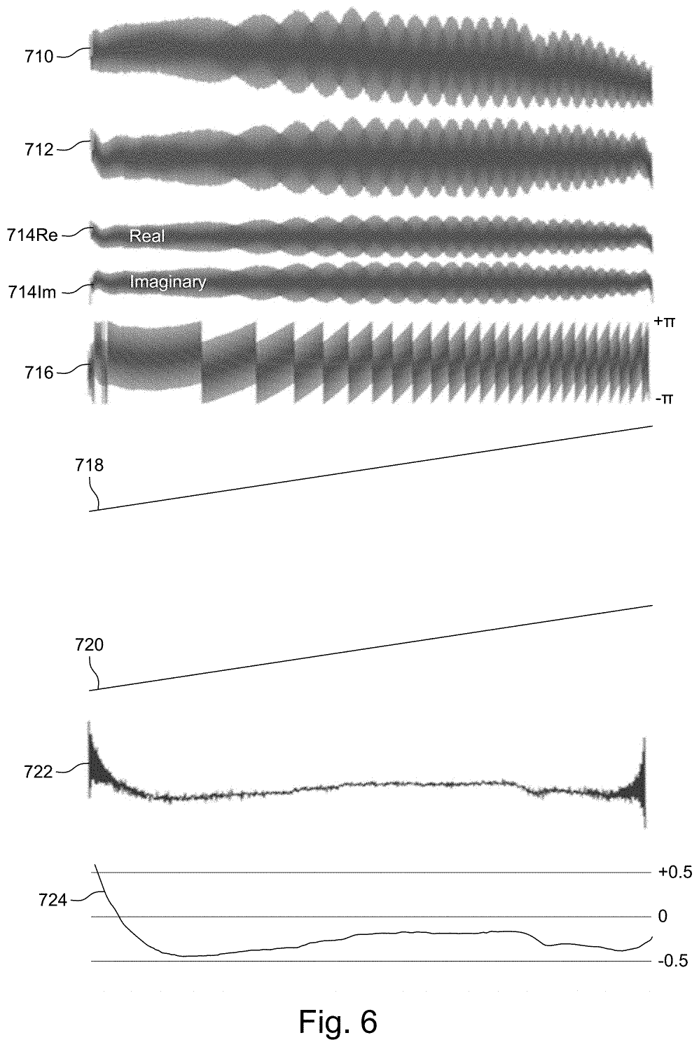

The OCT data is acquired in step 612 from the fixture. This data is shown as plot 710 of FIG. 6. Then the data is high pass filtered in 614. This data is shown as plot 712 of FIG. 6.

In step 616, a Hilbert transform is performed on the OCT data by the image processing computer. This data is shown as plots 714Re and 714Im of FIG. 6, corresponding to the real and imaginary components. Then, in step 618, the phase angle is determined from the transformed data. This data is shown as plot 716 of FIG. 6. In step 620, the phase is unwrapped. This data is shown as plot 718 of FIG. 6. While the plot of 718 looks nearly a straight line, there is the bow, which corresponds to the dispersion, and the deviations from the bow (sampling errors) are important.

Then in step 622, a second order (or higher order) polynomial is fit to the unwrapped phase. This data is shown as plot 720 of FIG. 6. In step 624, this calculation is performed: (UnwrappedPhase-fit)/(Derivative of fit), the subtraction and division are computed point-by-point in k-space by the image processing computer. This raw correction data is shown as plot 722 of FIG. 6. The raw correction is low pass filtered in step 626. The final filtered correction data is shown as plot 724 of FIG. 6 in fractions of a k-clock sample.

Multiwindow Processing

FFT window functions typically trade resolution for side-lobe amplitude. See F. J. Harris, “On the use of windows for harmonic analysis with the discrete Fourier transform,” Proc. of the IEEE, 66, 51-83 (1978). The higher the resolution, the worse the side lobes become.

In Y. Chen, J. Fingler, and S. Fraser, “Multi-shaping technique reduces sidelobe magnitude in optical coherence tomography,” Biomed. Opt. Express 8, 5267-5281 (2017), a technique for avoiding this tradeoff was proposed. The cost, however, was increased processing time. The technique used rectangular windows of various widths to move the sidelobes. By taking the minimum value of all the windowed images, a high sidelobe can be removed where another window has a minimum. The processing is simple: Apply several windows to the data and take the minimum of all the computed results. Processing time is multiplied by the number of windows used. By taking the minimum, the result tends to keep the high resolution and lower the side lobe clutter.

In contrast, the present approach does not rely on moving the sidelobes. Instead, it takes advantage of an adjustable window family that trades resolution for sidelobe level, depending on one or more adjustable parameters.

There are a number of adjustable window families that have this property. Examples include: Kaiser-Bessel windows, Dolph-Chebyshev windows, Taylor windows, and variable-width Gaussian windows. And, this is not an exhaustive list.

Instead of using a simple Hann window, the present approach takes the minimum of a series of Kaiser-Bessel windows. Kaiser-Bessel windows are a family of parameterized windows that trade resolution and side-lobe levels depending on the parameter β.

$$w ( n ) = \frac{{I}_{0} ( β \sqrt{1 - {( \frac{2 n}{N - 1} - 1 )}^{2}} )}{{I}_{0} ( β )}$$

I₀ is the zero-th order modified Bessel function of the first kind.

The windows must be scaled by the one divided by the mean of all the w(n) samples to make all spectrally flattened point spreads the same amplitude independent of the value of β. It is also best to spectrally flatten the A-lines before application of the parameterized window family.

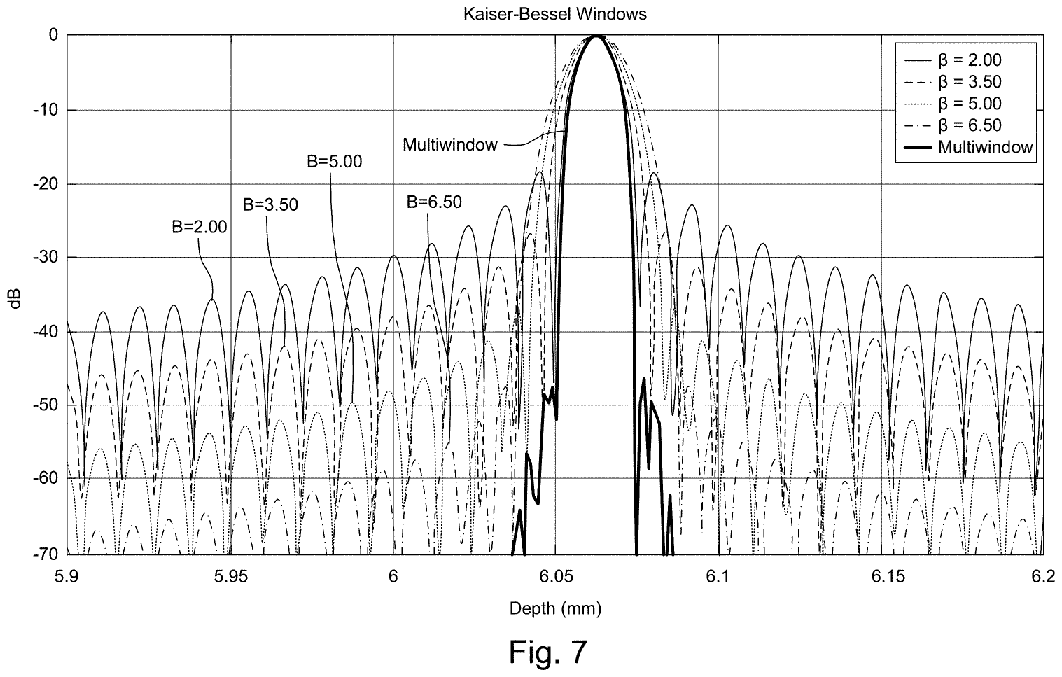

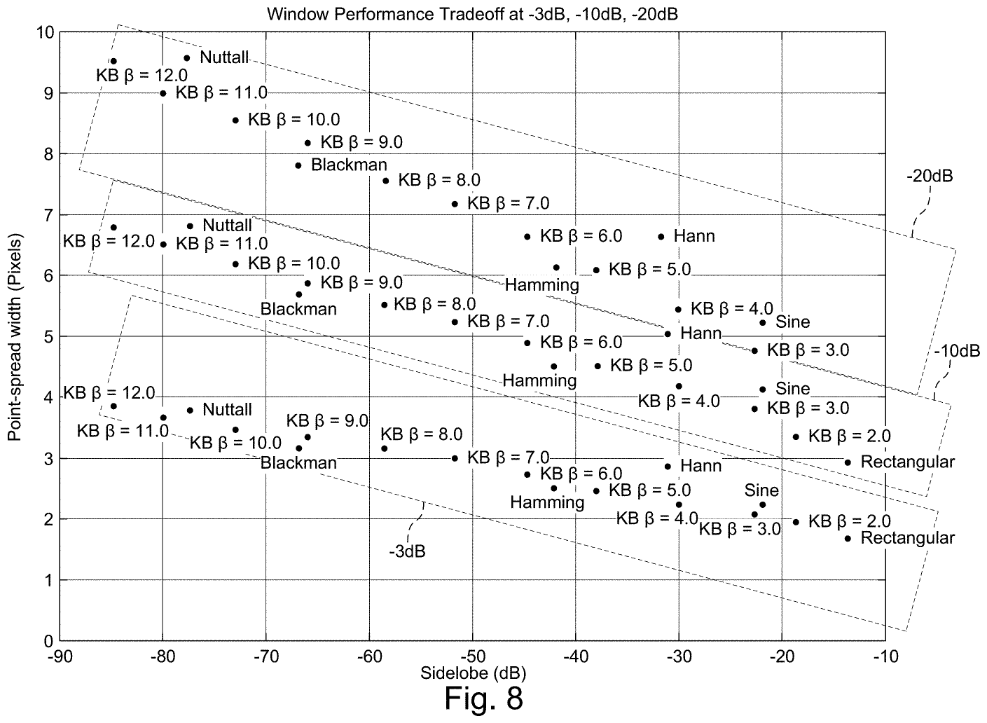

FIG. 7 shows a comparison of various Kaiser-Bessel windows with the multi-window result where β values of 1 to 10 in steps of 0.1 were used.

FIG. 8 is a plot showing the tradeoffs between spatial resolution and sidelobe level for a number of window types including Kaiser-Bessel of various P values. There are three groups of points falling in approximate straight lines. The resolutions plotted are for −3 dB, −10 dB, and −20 dB below the point spread peak.

Processing of Images

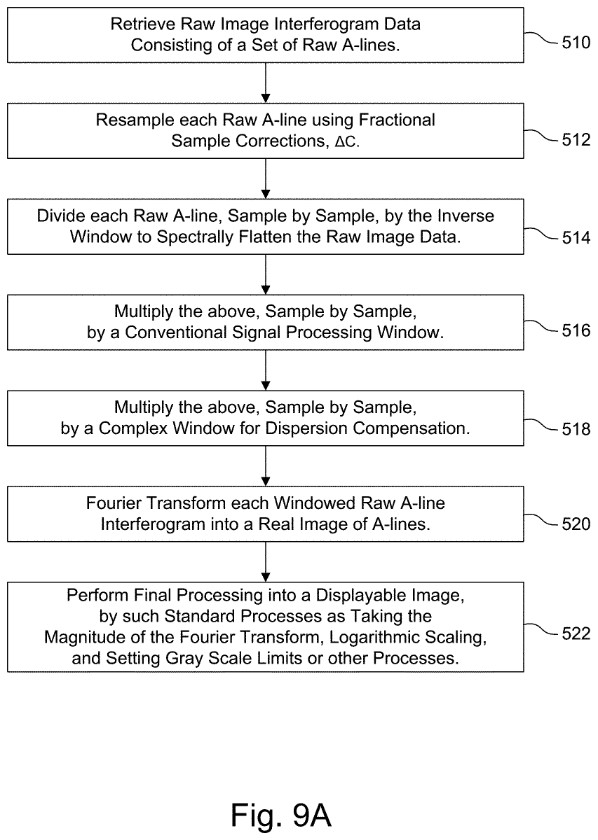

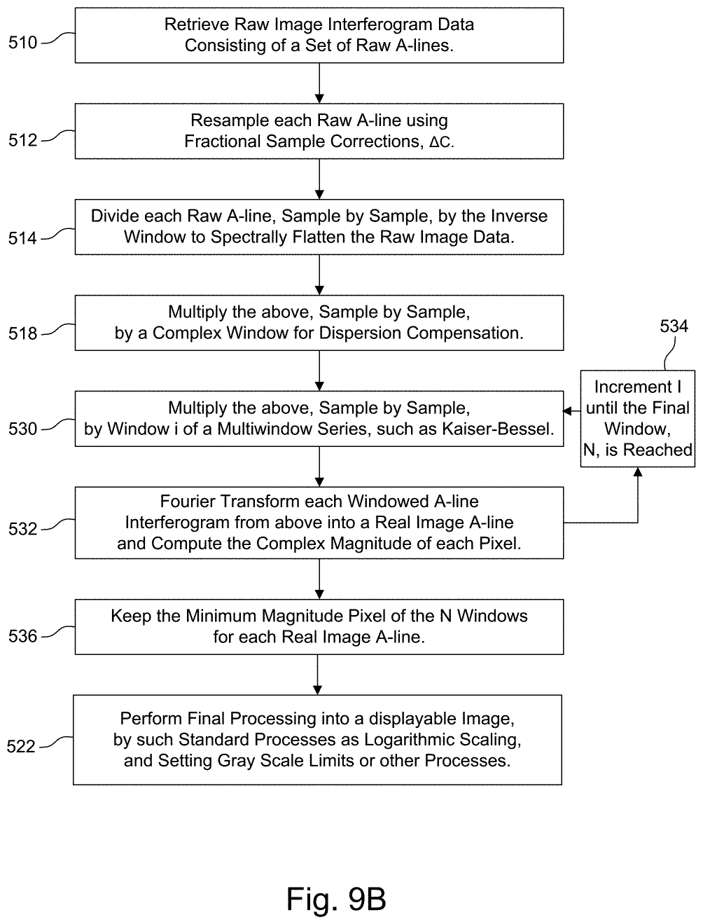

FIG. 9A shows the processing of each A-line to compensate and correct the OCT image interferogram data of a given sample S using a combination of conventional windowing along with spectral flattening and resampling.

In more detail, the process is performed for each raw A-line of a set of A-lines 510 taken of a sample S by the image processing computer.

Each raw A-line of a set of A-lines is resampled using fractional sample corrections, ΔC, in step 512. This can be avoided if resampling is not required.

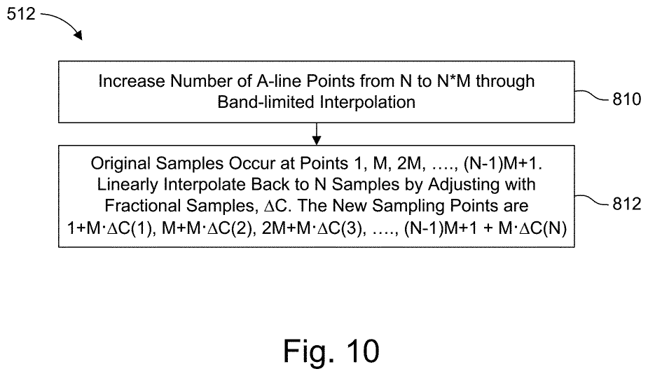

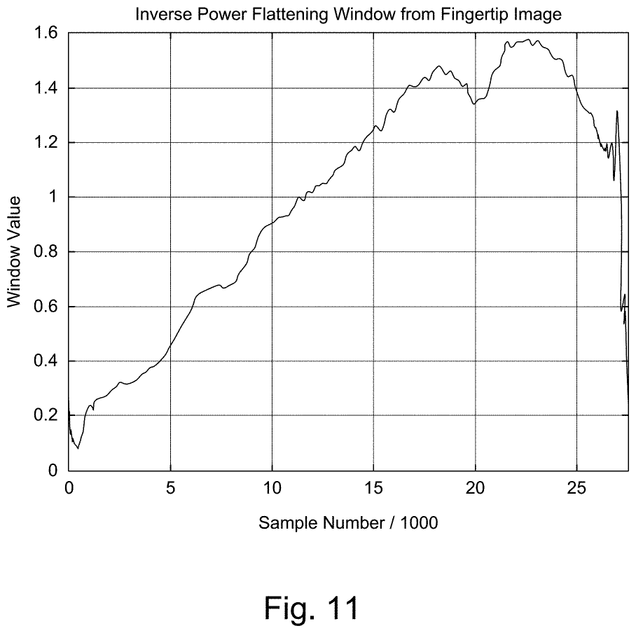

FIG. 10 shows the process by which the image processing computer generates the fractional sample corrections based on the final filtered correction data produced in step 626 of FIG. 5.

In step 810, the number A-line points in the scan of the sample is increased from N to N*M through band-limited interpolation.

The original samples now occur at points 1, M, 2M, . . . , (N−1)M+1. In step 812, the samples are linearly interpolated back to N samples by adjusting with fractional samples, ΔC.

The new sampling points are 1+M·ΔC(1), M+M·ΔC(2), 2M+M·ΔC(3), . . . , (N−1) M+1+M·ΔC(N).

That is, the sample correction in fractional samples is applied to the OCT data of a raw A-line. The samples are numbered 1, 2, 3, . . . , N. The corrections are in fractions of a sample, so sample 17 might be corrected to sample 17.21 through linear interpolation between samples 17 and 18. This does not work well for deep point spreads near the Nyquist depth. In that region, the data is too sparsely sampled. A band-limited interpolation step is performed to increase the point spacing before the linear interpolation step.

Returning to FIG. 9A, in step 514, each A-line of the set is then divided, sample by sample, by the inverse window determined during the calibration operation of FIG. 3.

In step 516, the A-lines are then multiplied by a conventional window such as Hann, Hamming, or other window.

In step 518, the A-line is then multiplied by a complex window for dispersion compensation. In general, dispersion compensation is performed by multiplying in a unit amplitude complex wave that has a parabolic or sometimes higher order phase change across the k-range.

In step 520, a Fourier transform is applied to the set of A-lines. Thus, the image processing computer transforms the A-lines into the image space and produces a three-dimensional image of the internal structures of sample S.

Finally in step 522, any final processing of the image into a displayable image is performed by the image processing computer. Often this processing includes taking the magnitude of the Fourier transform, logarithmic scaling, and setting gray scale limits or other processes.

FIG. 9B shows the method by which the image processing computer processes each A-line to compensate and correct the OCT image interferogram data of a given sample S using multiple window processing along with spectral flattening and resampling.

In general, this processing also performs steps 510, 512, 518 as described in connection with FIG. 9A.

However, step 516, multiplication by the conventional processing window, is skipped in the processing of FIG. 9B.

Instead in step 530, after step 518, each A-line is multiplied, sample by sample, by a window i of a multi window series such as the Kaiser-Bessel windows.

Then in step 532, Fourier transform of each windowed A-line interferogram is performed into image space and the complex magnitude of each pixel of those images is computed.

This process is repeated for each of the N windows in the Kaiser-Bessel window series as indicated by step 534 by the image processing computer.

Once the transforms have been performed for the windows of the series, in step 536, the minimum magnitude pixel for each of the N windows is retained by the image processing computer for the real image A-line.

Then, step 538 is performed in which final processing is performed by the image processing computer. This typically includes logarithmic scaling and setting gray scale limits and possibly other processing.

The following discussion illustrates the improved performance obtained from processing the OCT data as described above.

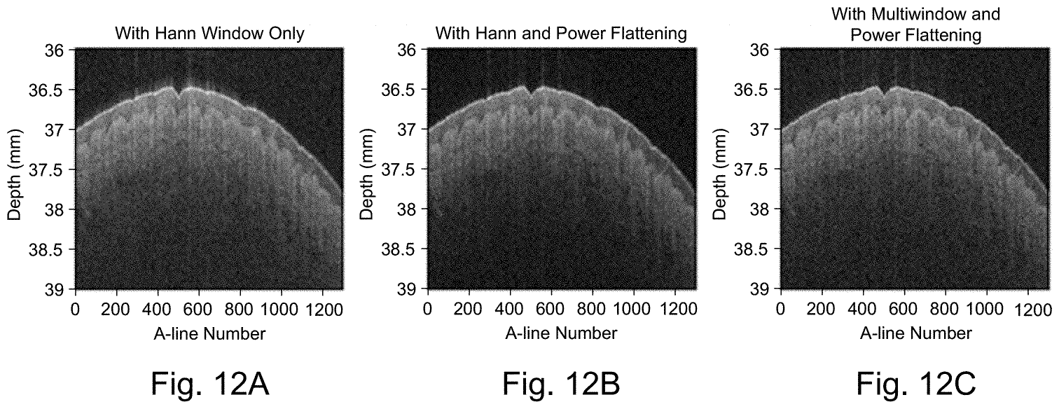

The spectral flattening window can also be extracted from images, if use of a calibration fixture is not possible. The inverse flattening window in FIG. 11 was extracted from the raw samples of the image of FIG. 12A, using the method of FIG. 3.

The images were processed three ways. The images were taken with a tunable VCSEL using software resampling.

FIG. 12B shows about 6 dB reduction in sidelobes at the edge of the fingertip in comparison to FIG. 12A, which was uncorrected. Much higher resolution is seen in FIG. 12C from multiwindow processing. The resolution is that of a rectangular window and more than 50 dB sidelobe suppression as seen in FIG. 12A. The multiwindow in FIG. 12C started with a rectangular window and followed with Kaiser-Bessel windows where β=1.1 to 12 in steps of 0.1.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for calibrating and processing A-lines in an optical coherence tomography system, the method comprising:
measuring a response of the system of a calibration fixture; and
performing spectral flattening of subsequent A-lines taken from a sample in response to the measured response of the calibration fixture.

2. A method as claimed in claim 1, wherein the calibration fixture includes a mirror.

3. A method as claimed in claim 1, further comprising resampling the A-lines.

4. A method as claimed in claim 3, wherein resampling comprises performing fractional sample correction of A-lines.

5. A method as claimed in claim 3, further comprising performing band-limited interpolation prior to resampling.

6. A method as claimed in claim 3, wherein the resampling is based on measuring the response of the system to the calibration fixture.

7. A method as claimed in claim 1, further comprising performing multi window processing of the A-lines.

8. A method as claimed in claim 7, wherein multi window processing includes employing parameterized windows.

9. A method as claimed in claim 7, wherein the windows include Kaiser-Bessel, Dolph-Chebyshev, or adjustable windows.

10. A method for processing A-lines in an optical coherence tomography system, comprising:
obtaining A-lines from a sample; and
performing multi window processing of the A-lines.

11. An optical coherence tomography system, comprising:
a sample interferometer;
a digital acquisition system for digitizing A-lines from the sample interferometer;
a calibration fixture for the sample interferometer; and
an image processing computer for performing spectral flattening of A-lines taken from a sample in response to a measured response to the calibration fixture.

12. A system as claimed in claim 11, wherein the calibration fixture includes a mirror.

13. A system as claimed in claim 11, wherein the image processing computer resamples the A-lines.

14. A system as claimed in claim 13, wherein resampling comprises performing fractional sample correction of A-lines.

15. A system as claimed in claim 13, wherein the image processing computer performs band-limited interpolation prior to resampling.

16. A system as claimed in claim 13, wherein the resampling is based on measuring the response of the system to the calibration fixture.

17. A system as claimed in claim 13, wherein the image processing computer performs multi window processing of the A-lines.

18. A system as claimed in claim 17, wherein multi window processing includes employing parameterized windows.

19. A system as claimed in claim 17, wherein the windows include Kaiser-Bessel, Dolph-Chebyshev, or adjustable windows.

20. An optical coherence tomography system, comprising:
a sample interferometer;
a digital acquisition system for digitizing A-lines from the sample interferometer; and
an image processing computer for performing multi window processing of the A-lines.
